(19) United States
(12) Patent Application Publication
(10) Pub. No.: US 2014/0375696 A1
(43) Pub. Date: Dec. 25, 2014

(54) IMAGE DISPLAY APPARATUS AND BACKLIGHT ADJUSTING METHOD THEREOF

(71) Applicant: Novatek Microelectronics Corp., Hsinchu (TW)

(72) Inventors: Yu-Hsing Chuang, Hsinchu City (TW); Chih-Yuan Yang, Hsinchu County (TW); Feng-Ting Pai, Hsinchu City (TW)

(73) Assignee: Novatek Microelectronics Corp., Hsinchu (TW)

(21) Appl. No.: 14/016,251

(22) Filed: Sep. 3, 2013

(30) Foreign Application Priority Data
Jun. 20, 2013 (TW) 102121985

(51) Int. Cl. G09G 5/10

(52) U.S. Cl. CPC G09G 5/10
USPC 345/690

(57) ABSTRACT

An image display apparatus and a backlight adjusting method are provided. The image display apparatus has a backlight module. The image display apparatus includes an ambient light sensor, an image content analyzer and a backlight controller. The ambient light sensor detects a luminance of ambient light. The image content analyzer receives an image data. The backlight controller sets a backlight basic value according to the luminance of ambient light, and sets a backlight adjusting ratio according to the image data and the luminance of ambient light. The backlight controller further sets a luminance of the backlight module according to the backlight basic value and the backlight adjusting ratio.

### CROSS-REFERENCE TO RELATED APPLICATION

This application claims the priority benefits of Taiwan application serial no. 102121985, filed on Jun. 20, 2013. The entirety of the above-mentioned patent application is hereby incorporated by reference herein and made a part of this specification.

### BACKGROUND OF THE INVENTION

1. Field of the Invention

The invention relates to an image display apparatus capable of adjusting a backlight, and more particularly to an image display apparatus capable of adjusting a backlight according to a luminance of ambient light and a luminance of an image data.

2. Description of Related Art

With electronic products popularized in recent years, it is has become important for designers to provide a high quality display apparatus for electronic devices. In order to meet the demand for mobility of the electronic devices, users need to be provided with the high quality display apparatus for indoor use as well as outdoor use.

In conventional art, a display apparatus may adjust a luminance of a backlight module according to a luminance of ambient light. Nevertheless, in an outdoor environment which is relatively brighter, the luminance of the backlight module is usually adjusted to its maximum luminance in order to resist a glare reflection effect, resulting waste in power consumption. In addition, in order to effectively save power, a display apparatus of convention art may properly reduce the luminance generated by the display apparatus by adjusting a luminance of a display image. However, in the outdoor environment which is relatively brighter, reducing in the luminance of a display image may also lower quality of the image.

### SUMMARY OF THE INVENTION

The invention is directed to a display apparatus and a backlight adjusting method, in which a backlight can be adjusted in considering of both high display quality and power saving.

An image display apparatus of the invention has a backlight module. The image display apparatus includes an ambient light sensor, an image content analyzer and a backlight controller. The ambient light sensor detects a luminance of ambient light. The image content analyzer receives an image data. The backlight controller is coupled to the ambient light sensor and the backlight module. The backlight controller sets a backlight basic value according to the luminance of ambient light, and sets a backlight adjusting ratio according to the image data and the luminance of ambient light. The backlight controller further sets a luminance of the backlight module according to the backlight basic value and the backlight adjusting ratio.

In an embodiment of the invention, the backlight controller sets the luminance of the backlight module according to a product of the backlight basic value and the backlight adjusting ratio.

In an embodiment of the invention, the backlight controller generates the backlight adjusting ratio according to a larger one among a luminance of the image data and the luminance of ambient light.

In an embodiment of the invention, when the luminance of ambient light is not greater than a first luminance threshold value, the backlight basic value maintains equal to a first luminance value.

In an embodiment of the invention, when the luminance of ambient light is greater than the first luminance threshold value and less than a second luminance threshold value, the backlight basic value is proportional to the luminance of ambient light.

In an embodiment of the invention, when the luminance of ambient light is greater than the second luminance threshold value, the backlight basic value maintains equal to a second luminance value, wherein the second luminance value is greater than the first luminance value.

A backlight adjusting method of the invention is suitable for an image display apparatus, and the backlight adjusting method includes: detecting a luminance of ambient light and receiving an image data; setting a backlight basic value according to the luminance of ambient light; setting a backlight adjusting ratio according to the image data and the luminance of ambient light; and setting a luminance of the backlight module according to the backlight basic value and the backlight adjusting ratio.

Based on above, the invention can set the backlight basic value according to the luminance of ambient light, and determines a possible range for reducing the backlight according to the luminance of ambient light and the image data, so as to save power. Accordingly, the image displaying quality of the display apparatus may not be affected by either simply increasing the backlight or reducing the backlight merely for saving power. As a result, the invention may adjust the backlight in considering of both high display quality and power saving.

To make the above features and advantages of the disclosure more comprehensible, several embodiments accompanied with drawings are described in detail as follows.

### BRIEF DESCRIPTION OF THE DRAWINGS

FIG. 1 is a schematic diagram illustrating an image display apparatus 100 according to an embodiment of the invention.

FIG. 2 is a relation diagram illustrating a relation between a backlight and a luminance of ambient light according to an embodiment of the invention.

FIG. 3 is a relation diagram illustrating a relation between a backlight and a luminance of ambient light according to another embodiment of the invention.

FIG. 4 is a flowchart illustrating a backlight adjusting method according to an embodiment of the invention.

### DESCRIPTION OF THE EMBODIMENTS

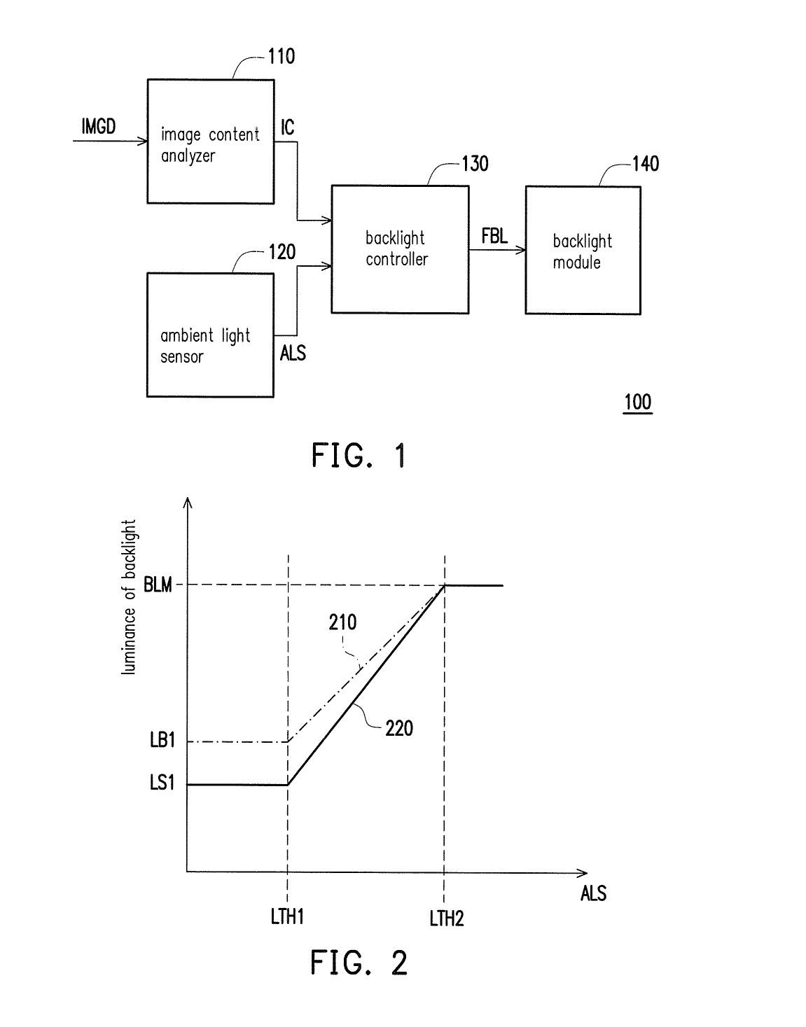

Referring to FIG. 1, FIG. 1 is a schematic diagram illustrating an image display apparatus 100 according to an embodiment of the invention. The image display apparatus 100 includes an image content analyzer 110, an ambient light sensor 120, a backlight controller 130 and a backlight module 140. The ambient light sensor 120 is configured to detect a luminance of ambient light ALS on where the image display apparatus 100 is located. The image content analyzer 110 is configured to receive an image data IMGD for displaying image. The image content analyzer 110 analyzes a luminance of the image data IMGD and generates an image data analysis result IC. In the present embodiment, the image data analysis result IC may be generated according to the image data IMGD with an average luminance, a maximum luminance or a luminance with highest probability of appearing within the same frame of the image data.

The ambient light sensor 130 is coupled to the ambient light sensor 120 and the image content analyzer 110. The backlight controller 130 receives the image data analysis result IC and the luminance of ambient light ALS. The backlight controller 130 sets a backlight basic value according to the luminance of ambient light ALS, and sets a backlight adjusting ratio according to the image data analysis result IC and the luminance of ambient light ALS. The backlight controller 130 further sets a luminance of the backlight module 140 according to the backlight basic value and the backlight adjusting ratio.

More specifically, referring to FIG. 2 and FIG. 1 together, FIG. 2 is a relation diagram illustrating a relation between a backlight and a luminance of ambient light according to an embodiment of the invention. Therein, when the luminance of ambient light ALS is not greater than a first luminance threshold value LTH1, the backlight controller 130 sets the backlight basic value to be maintained equal to a luminance value LB1, as shown in a curve 210. When the luminance of ambient light ALS falls between the first luminance threshold value LTH1 and a second luminance threshold value LTH2, the backlight controller 130 sets the backlight basic value to be proportional to the luminance of ambient light ALS as shown in the curve 210, and backlight basic value is linearly increased from the luminance value LB I. When the luminance of ambient light ALS is equal to or greater than the second luminance threshold value LTH2, the backlight basic value is set to be equal to a maximum luminance value BLM that the backlight module 140 can possibly present.

In addition, the backlight controller 130 further generates the backlight adjusting ratio according to the image data analysis result IC and the luminance of ambient light ALS The backlight adjusting ratio is configured to further adjust the backlight basic value. For instance, an adjusting relation between the backlight and the luminance of ambient light ALS can be defined as a function BL(ALS); an adjusting relation between the backlight and the image data analysis result IC can be defined as a function BL(IC); and the backlight adjusting ratio is a maximum value of the values obtained from the function BL(ALS) and the function BL(IC). In other words, the backlight controller 130 may set the backlight adjusting ratio with respect to both the luminance of ambient light ALS and the luminance of the image data, so as to be in considering of both display quality and power consumption.

The backlight controller 130 further sets the luminance required to be generated by the backlight module 140 according to the backlight adjusting ratio and the backlight basic value. More specifically, the backlight controller 130 multiplies the backlight adjusting ratio with the backlight basic value to generate a control signal FBL, and the control signal FBL, is transmitted to the backlight module 140, so that the backlight module 140 may generate a corresponding luminance.

In FIG. 2, the luminance generated by the backlight module 140 is as shown in a curve 220. Therein, when the luminance of ambient light ALS is not greater than the first luminance threshold value LTH 1, the backlight is equal to a luminance value LS 1. When the luminance of ambient light ALS falls between the first and the second luminance values LTH1 and LTH2, the backlight is increased from the luminance value

LS 1. When the luminance of ambient light ALS is greater than to equal to the second luminance threshold value LTH2, the backlight is equal to the maximum luminance value BLM that the backlight module 140 can possibly present.

It should be noted that, the function BL(ALS) and the function BL(IC) may be preset according to characteristic of the display apparatus. In other words, different display apparatuses may have different values in the function BL(ALS) and the function BL(IC).

The function BL(ALS) and the function BL(IC) may also be constructed by a lookup table. In brief, take the function BL(ALS) as an example, the designer may store a plurality (with a limited number) of corresponding relations between the luminance of ambient light ALS and the backlight to a storage device, so that the function BL(ALS) may be obtained according to the luminance of ambient light ALS in a manner of lookup. Take the function BL(IS) as an example, the designer may store a plurality (with a limited number) of corresponding relations between the image data analysis results IC and the backlight to the storage device similarly, so that the function BL(IC) may be obtained according to the image data analysis results IC in the manner of lookup.

In addition, the first luminance threshold value LTH1 can be utilized to determine whether the display apparatus 100 is indoor or outdoor. When the luminance of ambient light ALS is not greater than the first luminance threshold value LTH1, it can be determined that the display apparatus 100 is indoor. In contrast, when the luminance of ambient light ALS is greater than the first luminance threshold value LTH1, it can be determined that the display apparatus 100 is outdoor.

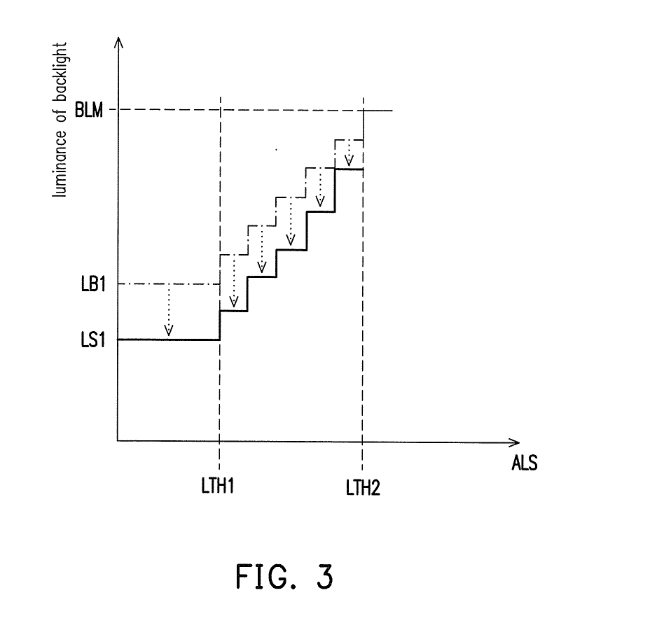

Referring to FIG. 3, FIG. 3 is a relation diagram illustrating a relation between a backlight and a luminance of ambient light according to another embodiment of the invention. A difference between the present embodiment and the embodiment of FIG. 2 is that, the backlight basic value in the embodiment of FIG. 3 is set to be stepwise-increased. In other words, the luminance of ambient light ALS that falls between the first luminance threshold value LTH1 and the second luminance threshold value LTH2 can be divided into a plurality of luminance regions, and the backlight controller 130 may set different backlight basic values corresponding to different luminance regions, and the backlight basic values corresponding to the same luminance region is identical. In addition, the backlight adjusting ratio and the backlight basic value can also be set according to the different luminance regions.

The backlight adjusting ratio corresponding to each of the luminance regions in the luminance of ambient light ALS can be different to each other. According to FIG. 3, in the luminance region with higher luminance of ambient light ALS, a degree of adjusting the backlight according to the backlight adjusting ratio may become smaller.

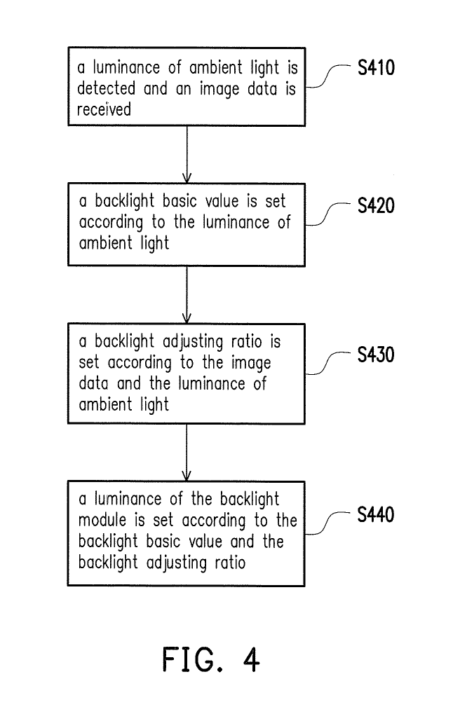

Referring to FIG. 4, FIG. 4 is a flowchart illustrating a backlight adjusting method according to an embodiment of the invention. In step S410, a luminance of ambient light is detected and an image data is received. In step S420, a backlight basic value is set according to the luminance of ambient light. In step S430, a backlight adjusting ratio is set according to the image data and the luminance of ambient light. In step S440, a luminance of the backlight module is set according to the backlight basic value and the backlight adjusting ratio.

Relevant implementation detail of adjusting backlight has been described in the previous embodiments and implementations, thus it is omitted hereinafter.

In summary, based on the invention, the backlight basic value is set according to the luminance of ambient light, the backlight adjusting ratio is set according to the luminance of ambient light and the luminance of image data, and the luminance required to be generated by the backlight module is set according to the backlight basic value and the backlight adjusting ratio. Accordingly, the display apparatus of the invention may adjust the backlight in considering of both high display quality and power saving.

What is claimed is:

1. An image display apparatus having a backlight module, and comprising:
an ambient light sensor detecting a luminance of ambient light;
an image content analyzer receiving an image data; and
a backlight controller coupled to the ambient light sensor and the backlight module, the backlight controller setting a backlight basic value according to the luminance of ambient light, setting a backlight adjusting ratio according to the image data and the luminance of ambient light, and setting a luminance of the backlight module according to the backlight basic value and the backlight adjusting ratio.

2. The image display apparatus of claim 1, wherein the backlight controller sets the luminance of the backlight module according to a product of the backlight basic value and the backlight adjusting ratio.

3. The image display apparatus of claim 1, wherein the backlight controller generates the backlight adjusting ratio according to a larger one among a luminance of the image data and the luminance of ambient light.

4. The image display apparatus of claim 1, wherein when the luminance of ambient light is not greater than a first luminance threshold value, the backlight basic value maintains equal to a first luminance value.

5. The image display apparatus of claim 4, wherein when the luminance of ambient light is greater than the first luminance threshold value and less than a second luminance threshold value, the backlight basic value is proportional to the luminance of ambient light.

6. The image display apparatus of claim 5, wherein when the luminance of ambient light is greater than the second luminance threshold value, the backlight basic value maintains equal to a second luminance value, wherein the second luminance value is greater than the first luminance value.

7. A backlight adjusting method for an image display apparatus, comprising:
detecting a luminance of ambient light and receiving an image data;
setting a backlight basic value according to the luminance of ambient light;
setting a backlight adjusting ratio according to the image data and the luminance of ambient light; and
setting a luminance of the backlight module according to the backlight basic value and the backlight adjusting ratio.

8. The backlight adjusting method of claim 7, wherein the step of setting the luminance of the backlight module according to the backlight basic value and the backlight adjusting ratio comprises:
setting the luminance of the backlight module according to a product of the backlight basic value and the backlight adjusting ratio.

9. The backlight adjusting method of claim 7, wherein the step of setting the backlight adjusting ratio according to the image data and the luminance of ambient light comprises:
generating the backlight adjusting ratio according to a larger one among a luminance of the image data and the luminance of ambient light.

10. The backlight adjusting method of claim 7, wherein when the luminance of ambient light is not greater than a first luminance threshold value, the backlight basic value maintains equal to a first luminance value.

11. The backlight adjusting method of claim 10, wherein when the luminance of ambient light is greater than the first luminance threshold value and less than a second luminance threshold value, the backlight basic value is proportional to the luminance of ambient light.

12. The backlight adjusting method of claim 11, wherein when the luminance of ambient light is greater than the second luminance threshold value, the backlight basic value maintains equal to a second luminance value, wherein the second luminance value is greater than the first luminance value.
